(19) United States
(12) Patent Application Publication
(10) Pub. No.: US 2012/0325450 A1
(43) Pub. Date: Dec. 27, 2012

(54) Connector for Tube-In-Tube Heat Exchanger and Methods of Making and Using Same

(76) Inventors: Tim Mimitz, Williamsburg, MA (US); Tim Mattson, Ellington, CT (US)

(21) Appl. No.: 13/582,157

(22) PCT Filed: Aug. 19, 2011
(86) PCT No.: PCT/US11/48455

§ 371 Date: Aug. 31, 2012

Related U.S. Application Data
(60) Provisional application No. 61/375,465, filed on Aug. 20, 2010.

(51) Int. Cl. F28F 1/00; B23P 15/26

(52) U.S. Cl. 165/177; 29/890.053

(57) ABSTRACT

A one-piece connector for a tube-in-tube heater exchanger comprising a T-shaped or Y-shaped outer tube is disclosed, along with a heat exchanger, a method of making the connector, and a method of making a heat exchanger.

### RELATED APPLICATIONS

This application claims priority from U.S. Provisional Application No. 61/375,465 filed Aug. 20, 2010.

### BACKGROUND

T-shaped and Y-shaped connectors are included in various fluid flow assemblies. U.S. Pat. No. 7,021,336 discloses a one-piece tee connector for a septic system that has directional vanes extending inwardly at an angle along the inner wall. U.S. Pat. No. 3,563,055 describes a refrigerant distributor with a plurality of diverging feed passages. U.S. Pat. No. 7,001,448 describes a fitting used in a system for separating a gas from a liquid in which the two phases are separated by swirling the liquid.

Connectors and fittings used in corrosive environments, such as tube-in-tube pool and spa water heat exchangers, require periodic replacement due to leaks and fouling. Multi-piece connectors are particularly prone to leaking along the points of connection between components. Additionally, fouling can occur along the inner walls of the components. When environmentally favorable heat transfer fluids are used, the high pressures required in the heat exchanger render the connectors even more susceptible to leaks.

It would be useful to develop a connector that has a longer useful life than conventional connectors and connection assemblies.

### SUMMARY

One embodiment described herein is a connector for a tube-in-tube heat exchanger, comprising a central conduit portion connected to a first tubular portion, a second tubular portion and a third tubular portion. The first tubular portion has an inner wall configured to receive a first fluid. The second tubular portion is disposed at an angle relative to the first tubular portion. The second tubular portion has an inner wall configured to receive a tube containing a second fluid. The third tubular portion is configured as a tube-in-tube heat exchanger inlet when the tube containing the second fluid is axially disposed therein. The third tubular portion has an inner wall defining an annular opening with the outer wall of the tube containing the second fluid, with the annular opening being configured to receive the first fluid. The central conduit portion, first tubular portion, section tubular portion and third tubular portion are integrally connected, forming a one-piece component.

In some cases, the central conduit portion includes an inwardly projecting protuberance to divert flow of fluid as the flow direction changes.

Another embodiment is a tube-in-tube heat exchanger comprising a connector that includes a central conduit portion connected to a first tubular portion, a second tubular portion and a third tubular portion. The first tubular portion has an inner wall configured to receive a first fluid. The second tubular portion is disposed at an angle relative to the first tubular portion. The second tubular portion has an inner wall configured to receive a tube containing a second fluid. The third tubular portion is configured as a tube-in-tube heat exchanger inlet when the tube containing the second fluid is axially disposed therein. The third tubular portion has an inner wall defining an annular opening with the outer wall of the tube containing the second fluid, with the annular opening being configured to receive the first fluid. The central conduit portion, first tubular portion, section tubular portion and third tubular portion are integrally connected, forming a one-piece component.

A further embodiment disclosed herein is a method of making a connector for a tube-in-tube heat exchanger comprising molding a rubber or plastic material in the shape of a one-piece component having the configuration described above. Another embodiment is a heat exchanger that includes the connector described above.

### BRIEF DESCRIPTION OF THE DRAWINGS

FIG. 1 is a side elevational view of a first embodiment of a connector.

FIG. 2 is a top plan view of the connector of FIG. 1.

FIG. 3 is a sectional view taken along line A-A of FIG. 1.

FIG. 4 is an end view taken from the refrigerant inlet end of the connector of FIG. 1.

FIG. 5 is a perspective view of a second embodiment of a connector, ferrule, also showing a ferrule and nut.

FIG. 6 is a side sectional view of the connector shown in FIG. 5.

FIG. 7 is an end view, taken from the left, of the connector shown in FIG. 6.

FIGS. 8 and 10 are opposite side elevational views of the connector shown in FIG. 6.

FIG. 9 is a top plan view of the embodiment shown in FIG. 6.

FIG. 11 is an end view, taken from the right, of the connector shown in FIG. 6.

FIG. 12 shows the connector of FIGS. 1-5, used in conjunction with one ferrule and one nut.

FIG. 13 shows a Y-shaped one-piece connector for a tube-in-tube heat exchanger.

FIG. 14 shows a heat exchanger incorporating the connector of FIGS. 1-4.

### DETAILED DESCRIPTION

One embodiment described herein is a tube-in-tube heat exchanger fitting that combines the function of several individual fittings, including a compression joint that seals to the inner tube of the heat exchanger, a means for closing off the ends of the heat exchanger, and a conduit for admitting fluid into the outer tube of the heat exchanger. The fitting has a longer useful life in which it maintains corrosion resistance as compared to a conventional fitting, due to fewer joints and a “self cleaning” configuration.

One configuration is a T-shaped fitting that allows water to enter a tube-in-tube heat exchanger in a direction perpendicular to the heat exchanger axis at the location of connection to the heat exchanger. The connector is a one-piece component that is used in conjunction with a ferrule and a nut.

Another configuration is a Y-shaped fitting that allows water to enter a tube-in-tube heat exchanger at an angle of about 20°-90° relative to the heat exchanger axis at the location of connection to the heat exchanger. The connector is a one-piece component that is used in conjunction with a ferrule and a nut.

An optional internal protuberance in the connector induces a swirled flow pattern, producing agitation that causes the fluid to clean the inner wall of the connector, thereby reducing both fouling and corrosion at the inner wall of the connector.

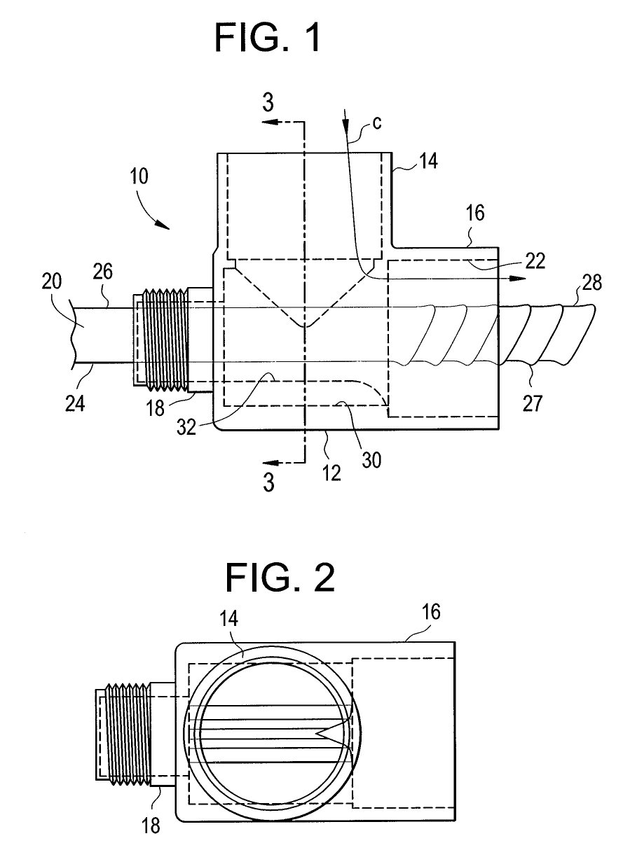

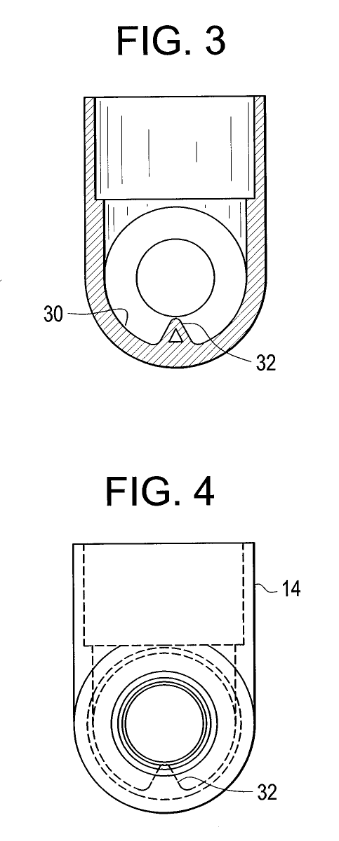

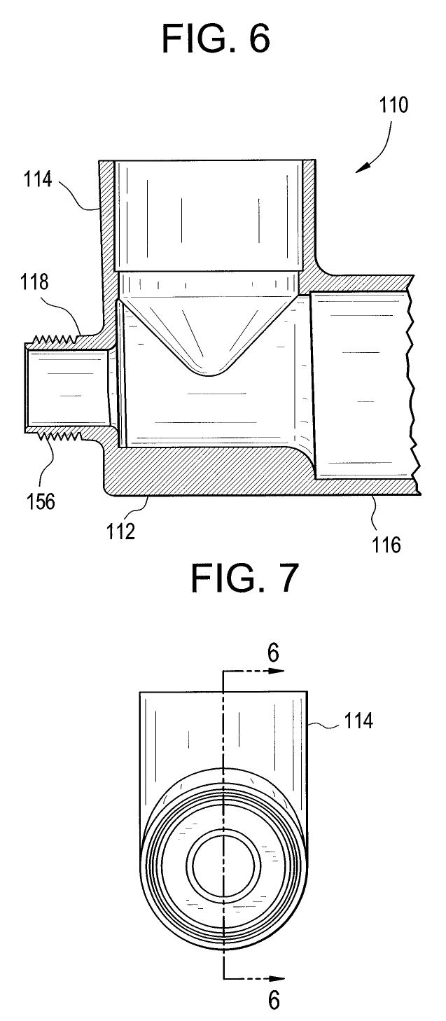

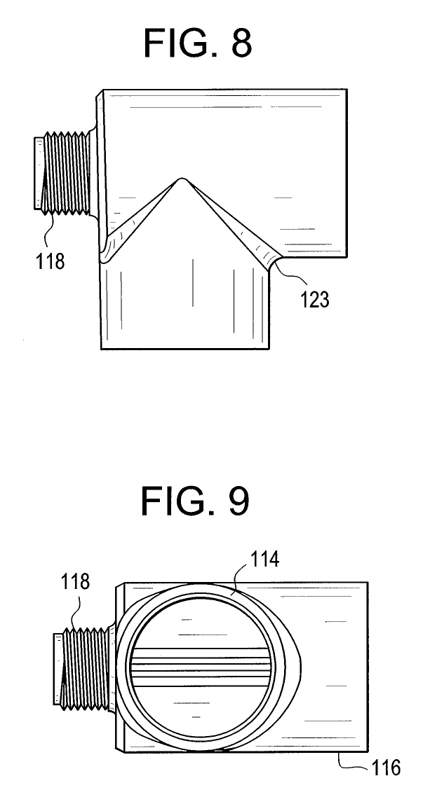

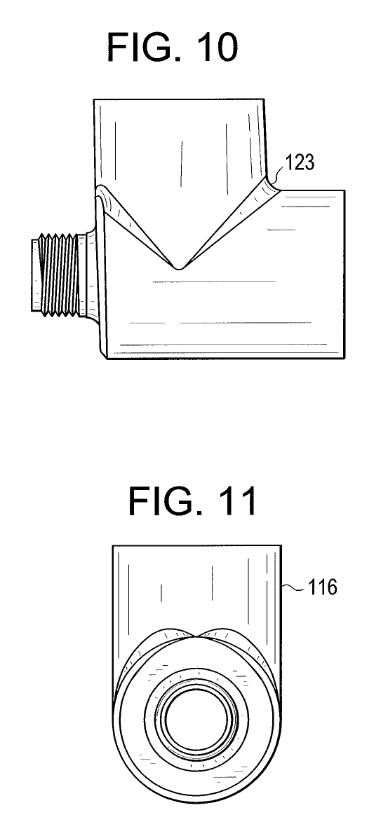

The embodiments of the connectors shown in FIGS. 1-14 are shorter than conventional connectors, thereby permitting new connectors to be retrofit into existing heat exchanger systems.

Referring first to FIGS. 1-4, a one-piece T-shaped connector is shown and is generally designated as 10. The connector 10 includes a central tubular portion 12 fluidly connected to a tubular inlet portion 14 and a tubular channel 16. The central tubular portion 12 is also connected to an inner tube-receiving portion 18. The central tubular portion 12 forms the vertex of the T. The tube-receiving portion 18 and the tubular channel 16 extend in opposite directions from the central tubular portion 12 to form the arms of the T. The tubular inlet portion 14 forms the “downwardly extending” part of the T (this portion may not be downwardly extending during use, but refers to the vertical portion of the letter “T”). The threaded tubular portion 18, central tubular portion 12 and tubular channel 16 are configured to receive an inner tube 20. The tubular inlet portion 14 is configured to receive a first fluid. The outer fluid generally flows along the path shown by arrow c through the central tubular portion 12 and the tubular channel 16, changing course by 90 degrees when it moves from the inlet portion 14 to the tubular channel 16. More specifically, the outer fluid flows through the tubular inner portion 12, central tubular portion 12 and into the annular channel defined by the inner wall 22 of the tubular channel 16 and the outer wall 24 of the tube 20. Fluid can flow either co-currently or countercurrently through the inner tube 20.

In the embodiment shown in FIGS. 1-4, the outer wall 24 of the inner tube 20 includes a smooth portion 26 inside the central tubular portion 12 and a twisted portion 27 with a plurality of flutes 28 inside the tubular channel 16. The flutes increase the rate of heat transfer between the inner and outer fluids.

The tube-receiving portion 18 has smaller outer and inner diameters than the tubular inlet portion 18 because it is configured to receive the inner tube 20 but is not configured to receive a fluid on the outside of the inner tube 20. The inner tube 20 is part of a heat exchanger, but is not part of the connector 10.

The inner wall 30 of the central tubular portion 12 has a protuberance 32 extending inwardly along the side opposite to the tubular inlet portion 14. In the embodiment shown in FIG. 1-4, the protuberance is configured as an elongated ridge with an apex 32 in the embodiment shown in FIGS. 1-4, but other configurations also can be used. The protuberance 32 causes the outer fluid to keep the inner wall of the connector and/or the outer wall of the inner tube 20 free of fouling due to turbulence in the flow pattern. The protuberance can extend inwardly (and optionally also angularly) at any place along the inner wall of the central conduit portion that results in enhanced turbulence of the outer fluid.

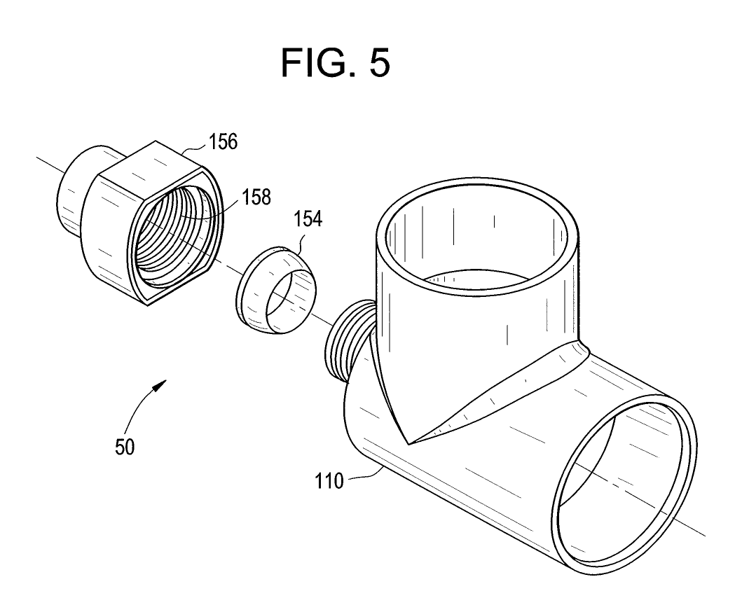

FIGS. 5-11 show various parts and views of a fitting assembly 50 including another embodiment of a connector, designated as 110, a ferrule 154 and a nut 156. The three-piece assembly replaces a conventional six-piece assembly that includes a nut, two ferrules, a dual threaded linear connector, a conventional tubular T, and a component to support the inner tube in a tube-receiving portion of the conventional tubular T. In the embodiment shown in FIGS. 5-11, the tube-receiving portion 118 of the connector 110 has an external thread configured to be received in the internal threaded portion 158 of the nut 156. Reinforced portion 123 provides added strength to the connector. The connector 110 of this embodiment is similar to the connector shown in FIGS. 1-4 except that it does not include a protuberance inside the central tubular portion 112.

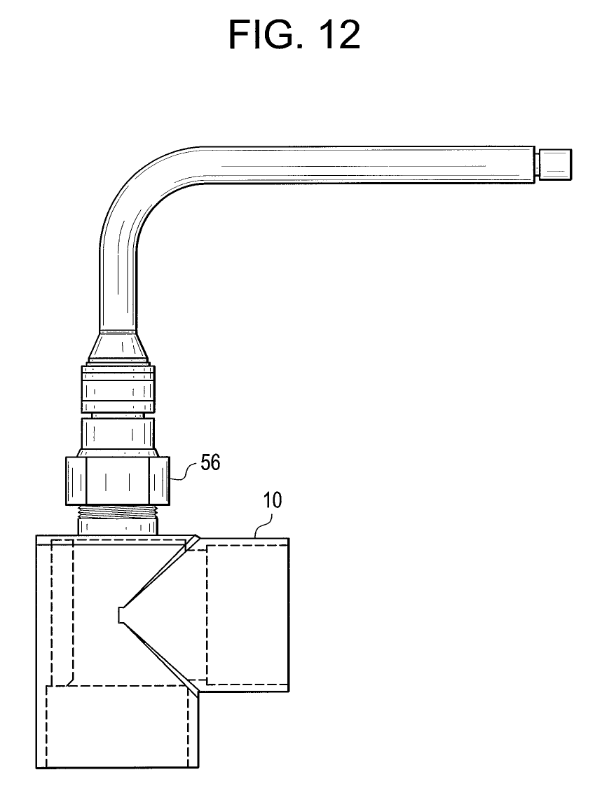

FIG. 12 shows a connector 10 that is connected to an inner tube with a nut 56. The connector has a longer useful life than the conventional connectors that have three separate pieces in place of the one-piece connector 10.

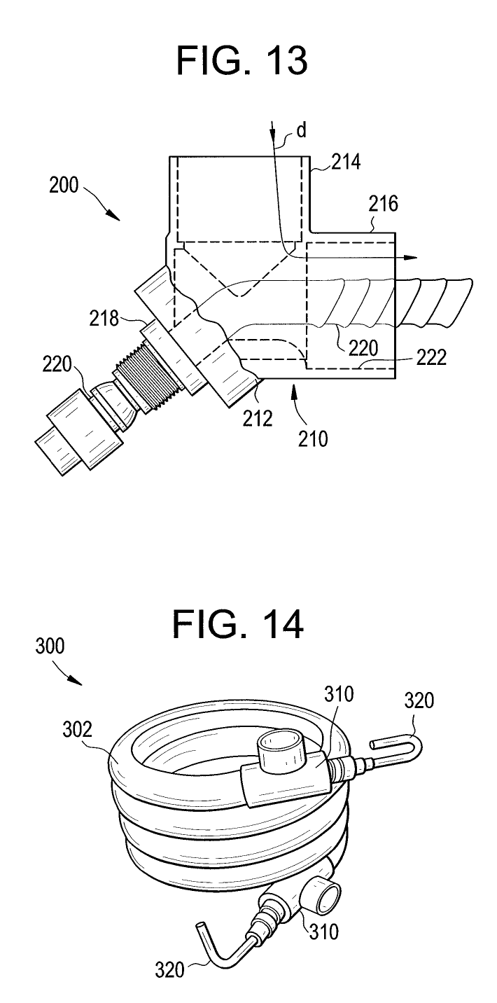

FIG. 13 depicts, partly as a side elevational view and partly broken away, a connector assembly 200 including a Y-shaped connector 210 for a tube-in-tube heat exchanger. The connector 210 includes a central tubular portion 212 fluidly connected to a tubular inlet portion 214 and a tubular channel 216. The central tubular portion 212 is also connected to an inner tube-receiving portion 218. The tubular inlet portion 214 and the tubular channel 16 form the branches of the Y. The central tubular portion 212 forms the vertex of the Y and part of the “downwardly extending” part of the Y. The tube-receiving portion 218 forms the rest of the “downwardly extending” part of the Y. The tube-receiving portion 218, central tubular portion 212 and tubular channel 216 are configured to receive an inner tube 220. The tubular inlet portion 214 is configured to receive a first fluid. The outer fluid generally flows along the path shown by arrow 2 through the central tubular portion 212 and the tubular channel 216, changing course by 20-90 degrees when it moves from the inlet portion 214 to the tubular channel 216. More specifically, the outer fluid flows through the tubular inner portion 212, central tubular portion 212 and into the annular channel defined by the inner wall 222 of the tubular channel 216 and the outer wall 224 of the tube 220. The Connector 220 optionally has an inner protuberance 232 to increase turbulence of the outer fluid in order to self-clean the inner walls of the central conduit portion 212 and the tubular channel 216.

FIG. 14 shows a tube-in-tube heat exchanger, designated as 300. The heat exchanger includes an outer tube 302, an inner tube 320, and two connectors 310. The connectors can have the configuration of any one of connectors 10, 110 and 210 described above. While the connector has been described above as being positioned at the inlet for the outer fluid, the connector can be positioned either at the inlet or the outlet for the outer fluid. In the embodiment in which the connector is positioned at the outlet for the outer fluid, the first tubular portion has an inner wall to receive an outer fluid in the flow direction opposite to flow directions c and d in FIGS. 1 and 13.

The connector is formed from a thermoplastic or thermoset polymeric material having resistance to corrosion by chemicals present in the fluids that are used in the heat exchanger. A connector to be used with chlorinated water can be formed from chlorinated polyvinylchloride (CPVC). CPVC connectors have been found to be useful and failure-resistant even when pool or spa water chemistry is not properly balanced. The connectors typically have inlet portions and tubular channels with outer diameters in the range of 1 to 4 inches.

The ferrule can be formed from a thermoplastic or thermoset material such as polyvinylidene fluoride (PVDF), or a thermoplastic copolyester based elastomer such as Arnitel (DSM).

### EXAMPLES

A set of connectors having the configuration shown in FIGS. 1-4 was formed from CPVC, along with a set of ferrules made of polyvinylidene fluoride (PVDF). The material was found to withstand exposure to chlorinated water (Samples 1 and 2B).

The connectors were subjected to an accelerated water hammer test (Sample 3), and were compared to a conventional connector (Spears). Testing took place using a cyclical load of 30 psig on low and 175 psig on high. The three connector in Sample 3, which had 1.5″ outer diameter, cracked at 3750 cycles, about 4500 cycles, and about 4500 cycles, respectively. It was determined that an increase in material thickness between the two perpendicular sections of the connector would eliminate the cracking problem.

A set of modified connectors having the configuration shown in FIGS. 1-4 were formed from chlorinated polyvinylchloride (CPVC), and PVDF ferrules were also were fabricated. The connectors had a 1.5″ outer diameter. Fatigue testing was conducted (Sample 4), and the new connectors outperformed conventional T-shaped connectors having generally the same dimensions. Three samples of the new connector were tested along with three samples of a conventional connector of the same diameter (made by Spears). Accelerated water hammer testing was conducted with a cyclical load of 50 psig on low and 175 psig on high. None of the new connectors failed during testing. The three conventional connectors cracked at 6,789, 7,173 and 8,441 cycles, respectively.

Additional samples of the same configuration were tested for temperature resistance (Sample 5A), sealing (Sample 5B), and torque (Sample 5C). All of the samples passed the tests.

Additional water hammer testing (Sample 6) was conducted and the samples passed a 10,000 cycle test. A glue strength test was also conducted (Sample 7) and the samples passed 300 psi for 1 minute. The burst pressure was determined to be 450-500 psi.

In the tests described in the previous paragraph, the connectors had a 2″ diameter with a 1″ thread for the ferrule. The torque on the ferrule was found to be 80 in-lb.

TABLE 1

| Sample No. | Purpose of testing | Results |
|---|---|---|
| 1 | Accelerated chlorine | No effect of chlorine on |
| | resistance of PVDF in 50, | PVDF observed in 5 |
| | 100, 150 ppm Dichlor | weeks. |
| | solution at 100° F. | |
| 2A | Leak strength, fatigue | Testing not performed |
| | strength | as samples received |
| | (min 5000 cycles) | had wall thickness |
| | | variation |
| 2B | Chlorine slurry test | The cut samples were |
| | | tested in a chlorine |
| | | slurry and compared |
| | | with Zurn fitting |
| 3 | Water hammer testing | Failed at bends. |
| | (fatigue strength: min | |
| | 5000 cycles) | |
| 4 | Water hammer testing | Passed 50,000 cycles. |
| | (fatigue strength: min | Fitting glued to make |
| | 5000 cycles) | connection with fatigue |
| | | tester failed. |
| 5A | Temperature rating of | Passed 10 hrs at 230° F. |
| | PVDF ferrules | under 100 psi water |
| | | pressure. No leakage |
| 5B | Sealing test | Passed 300 psi air |
| | | pressure for 1 min and |
| | | 150 psi water pressure |
| | | for 1 min. No leakage |
| 5C | Torque determination test | Passed 300 psi air |
| | | pressure for 1 min. The |
| | | sealing torque was |
| | | found to be 75 in-lb. No |
| | | leakage |
| 6 | Water hammer testing | Passed 10000 cycles. |
| | (fatigue strength: min | No leakage |
| | 5000 cycles) | |
| 7 | UL test data submittal and | Passed 300 psi for 1 min. |
| | glue strength evaluation | No leakage. Burst |
| | | pressure was |
| | | determined to be 450-500 psi |

The connector can be used for swimming pool and spa heat exchangers, marine aquariums, solar hot water heaters, and other tube-in-tube heat exchangers.

The above-disclosed and other features and functions, or alternatives thereof, may be combined into other different heat exchangers. Various presently unforeseen or unanticipated alternatives, modifications, variations, or improvements therein may be subsequently made by those skilled in the art, which are also intended to be encompassed by the following claims.

1. A connector for a tube-in-tube heat exchanger, comprising:
a central conduit portion connected to a first tubular portion, a second tubular portion and a third tubular portion,
the first tubular portion having an inner wall configured to receive a first fluid,
the second tubular portion disposed at an angle relative to the first tubular portion, the second tubular portion having an inner wall configured to receive a tube containing a second fluid, and
the third tubular portion configured as a tube-in-tube heat exchanger inlet when the tube containing the second fluid is axially disposed therein, the third tubular portion having an inner wall defining an annular opening with the outer wall of the tube containing the second fluid, the annular opening being configured to receive the first fluid,
wherein the central conduit portion, first tubular portion, section tubular portion and third tubular portion are integrally connected, forming a one piece component.

2. The connector of claim 1, wherein the connector has a longer useful life than a three piece connector having the same dimensions.

3. The connector of claim 1, wherein the central conduit portion has an inner wall with a protuberance configured to direct the first fluid in a swirled flow pattern.

4. The connector of claim 1, wherein the connector has a T shaped configuration.

5. The connector of claim 1, wherein the connector has a Y shaped configuration.

6. The connector of claim 1, further comprising a ferrule.

7. The connector of claim 6, further comprising a nut.

8. The connector of claim 7, wherein the second tubular portion has a threaded outer wall configured to receive the nut.

9. The connector of claim 1, wherein the connector is resistant to cracking when subjected to the Water Hammer Test.

10. The connector of claim 3, wherein the protuberance is elongated.

11. The connector of claim 3, wherein the protuberance has a V-shaped cross section.

12. A tube-in-tube heat exchanger comprising the connector of claim 1.

13. A method of making a connector for a tube-in-tube heat exchanger comprising molding the connector of claim 1.

14. A method of making a tube-in-tube heat exchanger using the connector of claim 1 to mount an inner tube inside an outer tube.
